(19) United States
(12) Patent Application Publication
(10) Pub. No.: US 2023/0166304 A1
(43) Pub. Date: Jun. 1, 2023

(54) METHOD FOR REMOVING COATINGS FROM SURFACES

(71) Applicant: Lufthansa Technik AG, Hamburg (DE)

(72) Inventors: Oliver Oeser, Borstel-Hohenraden (DE); Jens-Uwe Müller, Hamburg (DE); Claudia Bonelli, Hamburg (DE)

(21) Appl. No.: 17/916,035

(22) PCT Filed: Mar. 30, 2021
(86) PCT No.: PCT/EP2021/058243

§ 371 Date: Sep. 30, 2022

(30) Foreign Application Priority Data
Mar. 30, 2020 (DE) 10 2020 108 713.6

(51) Int. Cl. B08B 7/00; B64F 5/40

(52) U.S. Cl. CPC B08B 7/0014; B08B 7/0028; B64F 5/40

(57) ABSTRACT

A method removes coatings from a surface. The method includes: applying a stripping agent to the coating to be detached in order to produce a cohesive bond, such that the bond between the stripping agent and the coating to be detached is stronger than the bond between the coating to be detached and the surface; and stripping off the stripping agent together with the coating to be detached adhering thereto.

### CROSS REFERENCE TO RELATED APPLICATIONS

This application is a U.S. National Phase application under 35 U.S.C. § 371 of International Application No. PCT/EP2021/058243, filed on Mar. 30, 2021, and claims benefit to German Patent Application No. DE 10 2020 108 713.6, filed on Mar. 30, 2020. The International Application was published in German on Oct. 7, 2021 as WO 2021/198225 A1 under PCT Article 21(2).

### FIELD

The present disclosure relates to a method for removing coatings from surfaces, including for removing coatings that have become brittle under environmental influences from surfaces.

### BACKGROUND

The application of coatings, for example in the form of adhesive films, to surfaces, for example the outer skin of aircraft, is used for various purposes. In addition to the application of logos, lettering or other graphical elements using correspondingly designed films, aerodynamically functional films are also increasingly being used.

Aerodynamically functional films may come in various forms and application fields and regularly serve to reduce the wall shear stress on surfaces of bodies around which flow takes place. To this end, the aerodynamically functional films have a microstructured surface. A popular microstructure is the riblet structure, having very small ribs extending substantially in the main direction of flow. If corresponding riblet structures are applied to the outer skin of an aircraft, it is possible as a result for the flow resistance of the aircraft and thus the fuel consumption to be reduced.

Films provided for attachment to the outer skin of an aircraft are generally embodied in a thin manner for weight reasons. At the same time, they are exposed to significant environmental influences. In addition to being flowed over by air, in which particles such as sand or ice are entrained, which can mechanically damage the film or the aerodynamically functional surface thereof, the film is regularly exposed to intensive solar radiation, in particular in the case of commercial aircraft at cruising altitude.

On account of the damage that occurs in practice, it is necessary to regularly replace in particular aerodynamically functional films. However, it has been found that, on account of the small thickness and embrittlement on account of the intensive radiation with sunlight during operation of an aircraft, it is frequently difficult to remove the film applied to the outer skin of an aircraft. Complete removal without a trace, without the outer skin being damaged in the process, is currently only possible with chemical or mechanical processes that need to be carried out manually and are very time-consuming. With corresponding processes, it is also possible for dusts and/or chemical residues that are hazardous to health and/or environmentally hazardous to arise.

The situation is also similar for coatings in which paint has been applied to the surface and into which for example a desired microstructure has been embossed. These can also become brittle and have to be removed only with difficulty in order possibly to be renewed.

In addition to the described application to the outer skin of aircraft, corresponding coatings are also used on other surfaces, for example on the rotor blades of wind turbines or on high-speed trains, wherein they are exposed to comparable environmental influences, however, and likewise have to be removed after being damaged, before they can be renewed.

### SUMMARY

In an embodiment, the present disclosure provides a method that removes coatings from a surface. The method includes: applying a stripping agent to the coating to be detached in order to produce a cohesive bond, such that the bond between the stripping agent and the coating to be detached is stronger than the bond between the coating to be detached and the surface; and stripping off the stripping agent together with the coating to be detached adhering thereto.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a-d show a schematic illustration of a first exemplary embodiment of a method according to the present disclosure;

FIGS. 2a-d show a schematic illustration of a second exemplary embodiment of a method according to the present disclosure; and

FIGS. 3a-c show a schematic illustration of a third exemplary embodiment of a method according to the present disclosure.

### DETAILED DESCRIPTION

Aspects of the present disclosure provide to a method, which is improved compared with the prior art, for removing coatings, in particular coatings that have become brittle under environmental influences, from surfaces.

For example, according to one aspect of the present disclosure, a method is provided for removing coatings from surfaces, the method comprising the steps of:
applying a suitably selected stripping agent extensively to the coating to be detached in order to produce a cohesive bond, such that the bond between the stripping agent and the coating to be detached is stronger than the bond between the coating to be detached and the surface; and
stripping off the stripping agent together with the coating to be detached adhering thereto.

A number of terms used in the context of the present disclosure are explained below.

A first bond is “stronger” than a second bond when the first bond withstands a load at which the second bond fails. In the case of adhesive bonds, for example the adhesive force of the first bond F_{H1}, which needs to be overcome in order to release the first bond, is greater than the adhesive force of the second bond F_{H2} (F_{H1}>F_{H2}).

Conversely, a first bond is “weaker” than a second bond when the first bond yields under an identical load, while the second bond still endures. In the case of adhesive bonds, the adhesive force of the first bond F_{H1} is lower than the adhesive force of the second bond F_{H2} (F_{H1}<F_{H2}).

The present inventors have identified that a coating that has been applied to a surface and cannot not be readily stripped off directly, in particular because it has become brittle on account of environmental influences, can be removed when a stripping agent is first of all applied, which bonds so strongly to the coating to be detached that, during subsequent stripping off of the stripping agent, the coating sticks to the detaching agent and is thus stripped off together with the stripping agent. The tensile strength required for stripping off can be established solely by the stripping agent, and so the tensile strength of the coating to be stripped off and/or the degree of embrittlement thereof is no longer important.

In order that the coating to be detached also actually adheres to the stripping agent when the stripping agent is stripped off, and is consequently removed from the surface, the bond between the stripping agent and the coating to be detached should be stronger than the bond between the coating to be detached and the surface. Given sufficient information about the bond of the coating to be detached to the surface, for example about the adhesive used, it is possible to choose a suitable stripping agent without problems, but this choice can also be made on the basis of simple tests directly on the coating to be detached.

The stripping agent may be an at least one-sidedly adhesive, two-dimensional stripping compound which, to be applied, is pressed with an adhesive side onto the coating to be detached. The pressing on establishes the desired cohesive bond, necessary for the further process, between the stripping compound and the coating to be detached.

The stripping compound may be an adhesive stripping film. However, in order for it to be possible to establish a two-dimensional bond between the stripping compound and the compound to be detached, even in the case of damage to and/or microstructuring of the surface of the coating to be detached, it is preferred for the stripping compound to be deformable in a pressing-on direction. If the stripping compound is then pressed onto the coating to be stripped off, it can conform to said coating and be bonded to the latter all over, regardless of whether there is damage to and/or microstructuring of the surface of the coating to be stripped off. The stripping compound may in this case be plastically and/or elastically deformable.

In particular in the case of deformable stripping compounds, the tensile strength of the stripping compound may not be sufficient for it to be possible to strip the stripping compound together with the coating adhering thereto from the surface without problems. In particular in these cases, it is preferred for the stripping compound to have a tension-resistant stripping layer, preferably a stripping film, on the side facing away from the coating to be detached. With a corresponding stripping layer, the tensile strength of the stripping compound can be increased in order to allow the stripping agent to be stripped off, according to aspects of the present disclosure, together with the coating to be detached adhering thereto.

Alternatively to the use of a stripping compound as stripping agent, it is also possible to provide a curable substance as stripping agent, said substance bonding cohesively with the coating to be detached when it cures. After it cures, the substance forms a stripping agent suitable for stripping off together with the coating to be detached adhering thereto.

The curable substance may in this case be liquid or in the form of a gel in its initial state. Application of the substance extensively to a coating to be detached is thus easily possible. After it cures, the substance is solid.

It is also possible to extensively introduce into the not-yet-cured substance a mesh or a textile which is completely surrounded by the not-yet-cured substance. After the substance has cured, the mesh or textile may increase the tensile strength of the stripping agent.

Regardless of how the stripping agent is formed, it is preferred for it to be chosen such that a possible bond between the stripping agent and the surface is weaker than the bond between the stripping agent and the coating to be detached. Furthermore, it is preferred for a possible bond between the stripping agent and the surface to also be weaker than the bond between the coating to be detached and the surface. As a result, even in the case of systematic omissions in the coating to be detached or considerable damage to the coating to be detached, in the region of which the stripping agent comes into direct contact with the surface when it is pressed on, it is possible to strip off the stripping agent without problems and in particular without damaging the surface.

The method according to an aspect of the present disclosure has proven to be particularly suitable for the stripping off of coatings with a microstructured surface. This is the case in particular when the coating has a riblet structure—surface structuring in the form of riblets. Since the tensile strength of the coating itself is not important in the method according to an aspect of the present disclosure for detaching the coating, the coating to be detached can be designed to be particularly thin and thus lightweight and forgo in particular tension-resistant additional layers that are otherwise frequently provided in the prior art.

The coating to be detached may be a film adhesively bonded to the surface or a paint layer applied to the surface, in each case possibly with a microstructured surface embossed into it. The surface may in particular be the outer skin of an aircraft, of a high-speed train or of a wind turbine rotor blade.

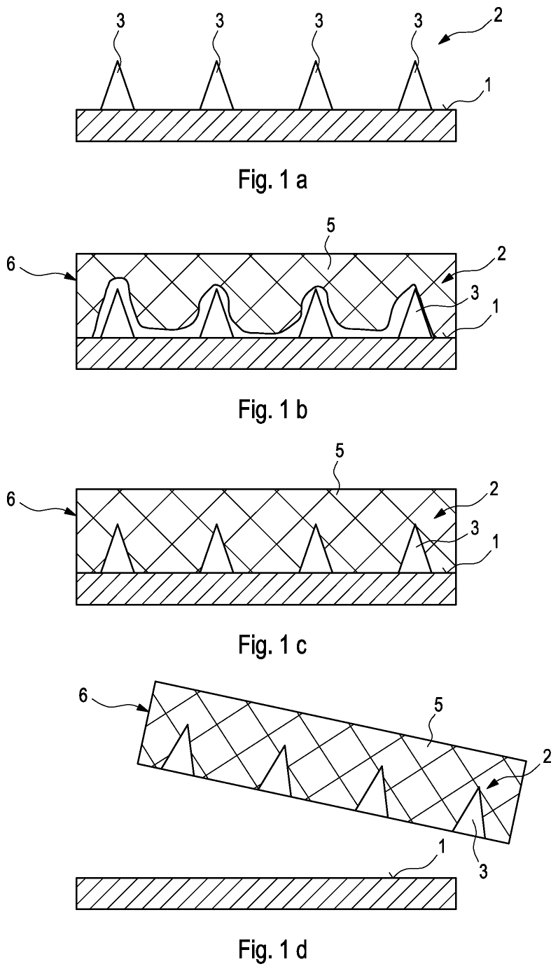

In FIG. 1a, to illustrate the first exemplary embodiment of a method according to an aspect of the present disclosure, a portion of the outer skin of a commercial aircraft is illustrated as the surface 1 on which, with the aid of a transfer film, individual riblets 3, which, if not also directly connected together, jointly form a film-like coating 2 to be detached in accordance with the present disclosure.

To detach the coating 2, first of all a stripping compound 5 is applied as stripping agent 6 to the coating 2 (FIG. 1b) and is subsequently pressed onto the coating 2, or onto the surface 1. Since the stripping compound 5 is deformable and is adhesive on its side facing the surface 1, an extensive or all-over cohesive bond between the stripping compound 5 and coating 2 is achieved (FIG. 1c). In this case, the adhesive property of the stripping compound 5 has been chosen such that the cohesive bond between the stripping compound 5 and coating 2 is stronger than the bond between the coating 2 and surface 1. At the same time, the cohesive bond between the stripping compound 5 and surface 1 in the regions of the coating 2 between the individual riblets 3 should be low enough for the paint that regularly forms the outermost layer of the surface 1 not to be subsequently damaged.

Once the stripping compound 5 has been fully applied and pressed on, the stripping compound 5 can be stripped as stripping agent 6 from the surface 1, wherein, on account of the above-described relationships of the individual bonds between the surface 1, coating 2 and stripping compound 5, the coating 2 sticks to the stripping agent 6 and is thus removed from the surface 1 (FIG. 1d).

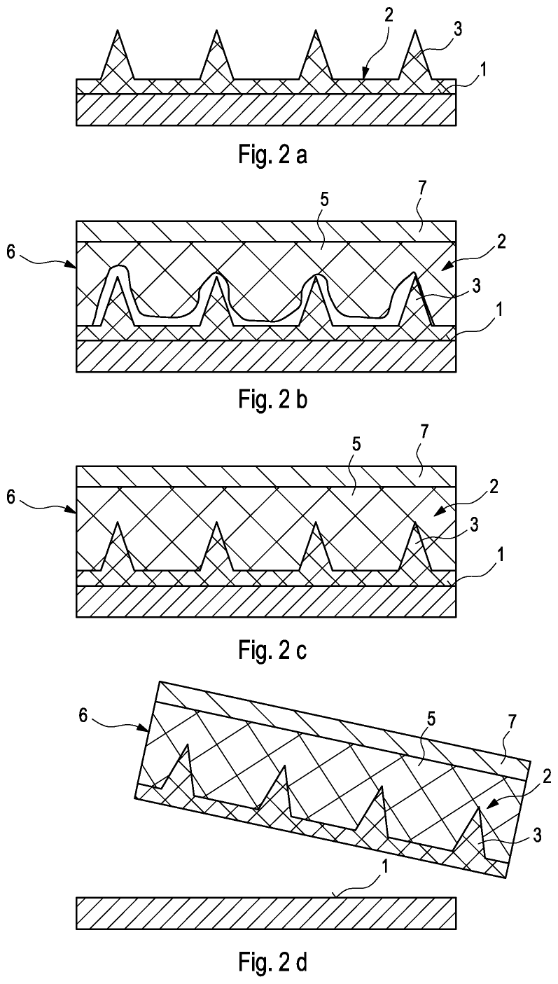

FIG. 2 illustrates a second exemplary embodiment of the method according to an aspect of the present disclosure. A generally continuous film with a microstructured surface comprising riblets 3 is arranged on the surface 1—or on the outer skin of an aircraft—as a coating 2 that is intended to be removed (FIG. 2a).

To detach the coating 2—in a comparable manner to the exemplary embodiment according to FIG. 1—first of all a stripping compound 5 is applied as stripping agent 6 with its adhesive side to the coating 2 (FIG. 2b) and is subsequently pressed onto the coating 2 or onto the surface 1 so as to result in a cohesive bond between the stripping agent 6 and coating 2 (FIG. 2c). The properties of the bond in relation to the bond between the coating 2 and surface 1 in this case correspond to the previous exemplary embodiment, and for this reason, reference is made to the corresponding statements.

On its side facing away from the surface 1, the stripping agent 6 has a stripping film 7 which is bonded non-detachably to the stripping compound 5 or embodied integrally therewith and increases the tensile strength of the stripping agent 6 in order in this way to make it easier to strip off the stripping agent 6 together with the coating 2 adhering thereto, as outlined in FIG. 2d.

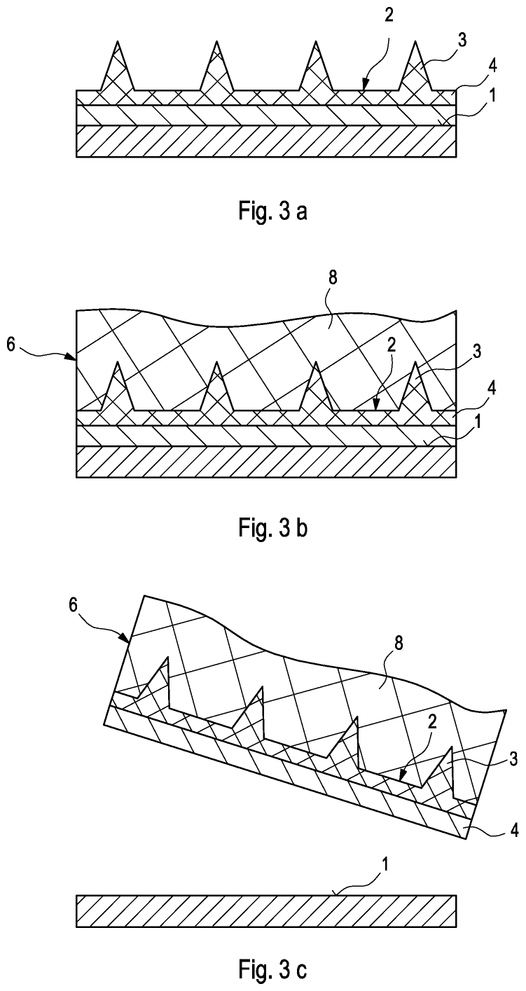

FIG. 3 illustrates a third exemplary embodiment of a method according to an aspect of the present disclosure.

The coating 2 with riblets 3 in this example is fastened with the aid of a backing film 4 to the surface 1—the outer skin of an aircraft—wherein the bond between the coating 2 and backing film 4 is stronger than the bond between the backing film 4 and surface 1.

As stripping agent 6, in this exemplary embodiment, a cured substance 8 in the form of a gel is applied to the coating 2 and cohesively bonds to the film 2 to be detached when it cures (FIG. 3b). The resultant cohesive bond between the stripping agent 6 and coating 2 is stronger than the bond between the coating 2 and surface 1, and so, when the stripping agent 6 is stripped off after the substance 8 has fully cured, the coating 2 adheres thereto and is thus removed from the surface 1 together with the backing film 4 (FIG. 3c).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for removing coatings from a surface, the method comprising:
applying a stripping agent to the coating to be detached in order to produce a cohesive bond, such that the bond between the stripping agent and the coating to be detached is stronger than the bond between the coating to be detached and the surface; and
stripping off the stripping agent together with the coating to be detached adhering thereto.

2. The method as claimed in claim 1, wherein the stripping agent is an at least one-sidedly adhesive, two-dimensional stripping compound which, during application, is pressed with an adhesive side onto the coating to be detached.

3. The method as claimed in claim 2, wherein the stripping compound is deformable in a pressing-on direction.

4. The method as claimed in claim 2, wherein the stripping compound has a tension-resistant stripping layer on the side facing away from the coating to be detached.

5. The method as claimed in claim 1, wherein the stripping agent is a curable substance which is configured to bonds with the coating to be detached in a cured state.

6. The method as claimed in claim 5, wherein the curable substance is liquid or in the form of a gel in its initial state.

7. The method as claimed in claim 1, wherein the stripping agent is chosen such that a possible bond between the stripping agent and the surface is weaker than the bond between the stripping agent and the coating to be detached.

8. The method as claimed in claim 1, wherein the coating to be detached has a microstructured surface.

9. The method as claimed in claim 1, wherein the coating to be detached is a film adhesively bonded to the surface or a paint layer applied to the surface.

10. The method as claimed in claim 1, wherein the surface is the outer skin of an aircraft, of a high-speed train, or of a wind turbine rotor blade.

11. The method as claimed in claim 4, wherein the tension-resistant stripping layer is a stripping film on the side facing away from the coating to be detached.

12. The method as claimed in claim 7, wherein the stripping agent is chosen such that the possible bond between the stripping agent and the surface is weaker than the bond between the coating to be detached and the surface.

13. The method as claimed in claim 8, wherein the microstructured surface comprises a riblet structure.
